(19) United States
(12) Patent Application Publication
(10) Pub. No.: US 2024/0370652 A1
(43) Pub. Date: Nov. 7, 2024

(54) METHOD, COMPUTER DEVICE, AND COMPUTER PROGRAM FOR REAL-TIME INSPECTOR IN LIVE COMMERCE PLATFORM

(71) Applicant: NAVER CORPORATION, Seongnam-si (KR)

(72) Inventors: Jooho YOON, Seongnam-si (KR); Jung Beom CHOI, Seongnam-si (KR); Taekbeom YOO, Seongnam-si (KR)

(21) Appl. No.: 18/777,986

(22) Filed: Jul. 19, 2024

Related U.S. Application Data
(63) Continuation of application No. PCT/KR2023/000936, filed on Jan. 19, 2023.

(30) Foreign Application Priority Data
Jan. 19, 2022 (KR) 10-2022-0007860

(51) Int. Cl. G06F 40/289; G06F 40/35; H04N 21/2187; H04N 21/478

(52) U.S. Cl. CPC G06F 40/289; G06F 40/35; H04N 21/2187; H04N 21/47815

(57) ABSTRACT

A method, a computer device, and a computer program for a real-time inspector in a live commerce platform may categorize chat messages received during live broadcasting of a host in real time by using a function of a live commerce tool for the host, analyze viewer messages in real time to visualize and provide analysis results, and provide, to users, automatic answers to inquiry messages about a broadcasting item of the host.

### CROSS-REFERENCE TO RELATED APPLICATIONS

This is a continuation application of International Application No. PCT/KR2023/000936, filed Jan. 19, 2023, which claims the benefit of Korean Patent Application No. 10-2022-0007860, filed Jan. 19, 2022.

### BACKGROUND OF THE INVENTION

### Field of Invention

The following description relates to technology for providing a chat-based live commerce service capable of communicating with a viewer in real time.

### Description of Related Art

With the development of the Internet, the e-commerce market is formed and a live commerce service through the Internet is active.

The live commerce service may be provided through a personal terminal in a form of a website or an application.

For example, technology capable of setting a specific webpage and providing an Internet broadcast through the corresponding webpage is disclosed in Korean Patent Laid-Open Publication No. 10-2012-0079039 (published on Jul. 11, 2012).

### BRIEF SUMMARY OF THE INVENTION

Example embodiments may classify viewer chat messages on a live commerce platform.

Example embodiments may analyze a viewer message in real time and may visualize and provide analysis results.

Example embodiments may provide an automatic response to an inquiry message for a broadcast item of a host.

According to an example embodiment, there is provided a method executed by a computer device, wherein the computer device includes at least one processor configured to execute computer-readable instructions included in a memory, and the method includes classifying, by the at least one processor, chat messages received during a live broadcast of a host using a function of a live commerce tool for the host.

According to an aspect of the present invention, classifying may include classifying the chat messages into a category corresponding to message content using a language model.

According to another aspect, the classifying of the chat messages may include constructing a prompt for a target message using example data that includes a message example and a category of a corresponding message; and generating a category of the target message according to a pattern of the example data by using the prompt as input to a language model.

According to still another aspect, the classifying of the chat messages may include setting a category that is a classification item of the chat messages for the live broadcast; and classifying the chat messages into the category and displaying the same through an interface screen configured with a template of the category.

According to still another aspect, the method may further include analyzing, by the at least one processor, the chat messages received during the live broadcast in real time using the function of the live commerce tool and providing analysis results.

According to still another aspect, providing analysis results may include visualizing positive and negative reaction rates based on the classification results of the chat messages.

According to still another aspect, providing analysis results may include generating and providing a highlight related to a specific classification item based on the classification results of the chat messages.

According to still another aspect, providing analysis results may include storing a message of a specific classification item based on the classification results of the chat messages, and the message of the specific classification item may be used as analysis data related to the host's product.

According to still another aspect, the method may further include providing, by the at least one processor, an automatic response to an inquiry message classified into an inquiry category among the chat messages using the function of the live commerce tool.

According to still another aspect, providing analysis results may include providing the automatic response based on a response dataset provided in advance by the host.

According to still another aspect, providing analysis results may include providing the automatic response based on at least one of the host's product information, a dataset converted from the host's voice through speech to text (STT), and a dataset accumulated from the host's previous broadcast.

According to still another aspect, providing analysis results may include automatically posting a corresponding inquiry and response to a bulletin board related to the host's product for the inquiry message to which the automatic response was successfully generated.

According to still another aspect, providing analysis results may include providing the inquiry message to which the automatic response has failed through a separate interface.

According to an example embodiment, there is provided a non-transitory computer-readable recording medium storing a computer program for executing the method for classifying chat messages on the computer device.

According to an example embodiment, there is provided a computer device including at least one processor configured to execute computer-readable instructions included in a memory, wherein the at least one processor is configured to classify chat messages received during a live broadcast of a host using a function of a live commerce tool for the host.

According to example embodiments, it is possible to classify viewer chat messages on a live commerce platform.

According to example embodiments, it is possible to analyze a viewer message in real time and to visualize and provide analysis results.

According to example embodiments, it is possible to provide an automatic response to an inquiry message for a broadcast item of a host.

### BRIEF DESCRIPTION OF THE DRAWINGS

FIG. 1 is a diagram illustrating an example of a network environment according to an example embodiment.

FIG. 2 is a block diagram illustrating an example of a computer device according to an example embodiment.

FIG. 3 is a block diagram illustrating an example of the components included in a processor of a computer device according to an example embodiment.

FIG. 4 is a flowchart illustrating an example of a method performed by a computer device according to an example embodiment.

FIG. 5 is a flowchart illustrating an example of a message classification process using a prompt according to an example embodiment.

FIGS. 6 and 7 illustrate category classification examples according to an example embodiment.

FIG. 8 illustrates an example of a live commerce interface screen according to an example embodiment.

FIGS. 9 to 11 illustrate examples of an interface screen of a live commerce tool according to an example embodiment.

FIGS. 12 and 13 illustrate other examples of an interface screen of a live commerce tool according to an example embodiment.

### DETAILED DESCRIPTION OF THE INVENTION

Hereinafter, some example embodiments will be described with reference to the accompanying drawings.

Example embodiments relate to technology for providing a live commerce service capable of communicating with a viewer in real time.

Example embodiments including those specifically disclosed herein may provide an inspector with various functions of processing chat messages in real time on a chat-based live commerce platform.

A live inspector system according to the example embodiments may be implemented by at least one computer device and a live inspector method according to the example embodiments may be performed by at least one computer device included in the live inspector system. Here, a computer program according to an example embodiment may be installed and executed on the computer device, and the computer device may perform the live inspector method according to the example embodiments under the control of the executed computer program. The aforementioned computer program may be stored in a computer-readable storage medium to computer-implement the live inspector method in conjunction with the computer device.

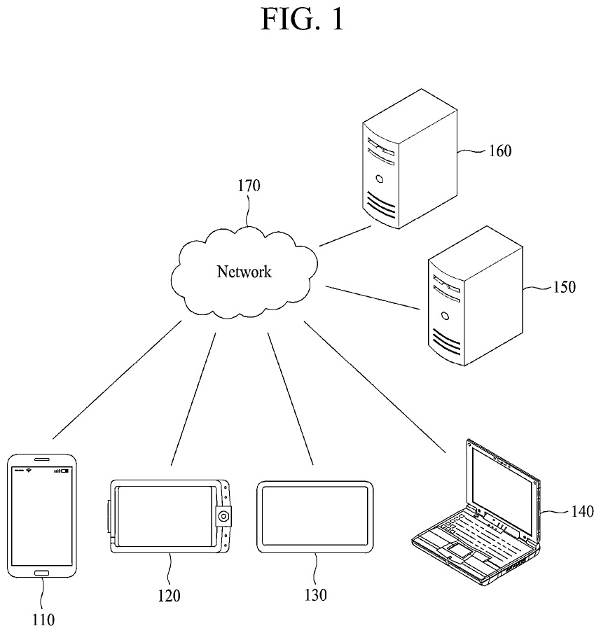

FIG. 1 illustrates an example of a network environment according to an example embodiment. Referring to FIG. 1, the network environment may include a plurality of electronic devices 110, 120, 130, 140, a plurality of servers 150, 160, and a network 170. FIG. 1 is provided as an example only. The number of electronic devices or the number of servers is not limited thereto. Also, the network environment of FIG. 1 is provided as an example only among environments applicable to the example embodiments and the environment applicable to the example embodiments is not limited to the network environment of FIG. 1.

Each of the plurality of electronic devices 110, 120, 130, 140 may be a fixed terminal or a mobile terminal that is configured as a computer device. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer devices capable of communicating with other electronic devices 120, 130, 140 and/or the servers 150, 160 over the network 170 in a wireless or wired communication manner.

The communication scheme is not limited and may include a near field wireless communication scheme between devices as well as a communication scheme using a communication network (e.g., mobile communication network, wired Internet, wireless Internet, and broadcasting network) includable in the network 170. For example, the network 170 may include at least one network among networks that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, 140 over the network 170. For example, the server 150 may be a system that provides a first service to the plurality of electronic devices 110, 120, 130, 140 connected through the network 170 and the server 160 may be a system that provides a second service to the plurality of electronic devices 110, 120, 130, 140 connected through the network 170. As a specific example, the server 150 may provide a service (e.g., live commerce service) desired by a corresponding application to the plurality of electronic devices 110, 120, 130, 140 through the application of the computer program that is installed and executed on the plurality of electronic devices 110, 120, 130, 140. As another example, the server 160 may provide a service that distributes a file for installing and executing the application to the plurality of electronic devices 110, 120, 130, 140 as the second service.

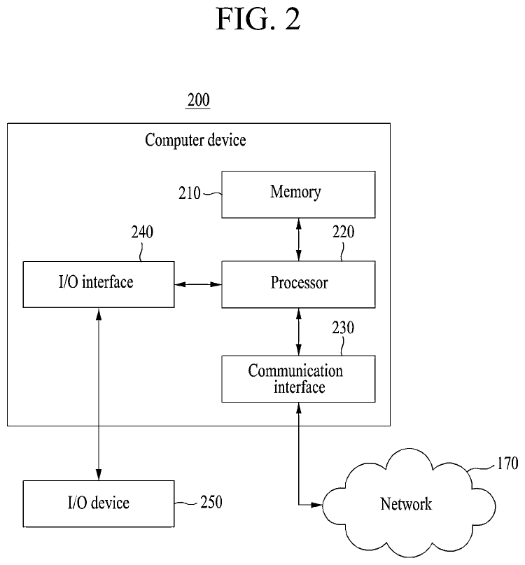

FIG. 2 is a block diagram illustrating an example of a computer device according to an example embodiment. Each of the plurality of electronic devices 110, 120, 130, 140 or each of the servers 150, 160 described above may be implemented by a computer device 200 of FIG. 2.

Referring to FIG. 2, the computer device 200 may include a memory 210, a processor 220, a communication interface 230, and an input/output (I/O) interface 240.

The memory 210 may include a permanent mass storage device, such as a random access memory (RAM), a read only memory (ROM), and a disk drive, as a computer-readable recording medium. The permanent mass storage device, such as ROM and a disk drive, may be included in the computer device 200 as a permanent storage device separate from the memory 210. Also, an operating system (OS) and at least one program code may be stored in the memory 210. Such software components may be loaded to the memory 210 from another computer-readable recording medium separate from the memory 210. The separate computer-readable recording medium may include, for example, a floppy drive, a disk, a tape, a DVD/CD-ROM drive, a memory card, etc. According to other example embodiments, software components may be loaded to the memory 210 through the communication interface 230, instead of the computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and another apparatus (e.g., the aforementioned storage devices) over the network 170. For example, the processor 220 of the computer device 200 may deliver a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the network 170 and the communication interface 230 of the computer device 200. For example, a signal, an instruction, data, etc., received through the communication interface 230 may be delivered to the processor 220 or the memory 210, and a file, etc., may be stored in a storage medium (e.g., the permanent storage device) further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include greater or less number of components than those shown in FIG. 2. For example, the computer device 200 may include at least a portion of the I/O device 250, or may further include other components, for example, a transceiver, a database, etc.

Hereinafter, specific example embodiments of a method and system for a real-time inspector on a live commerce platform are described.

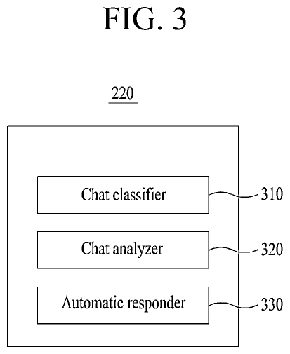

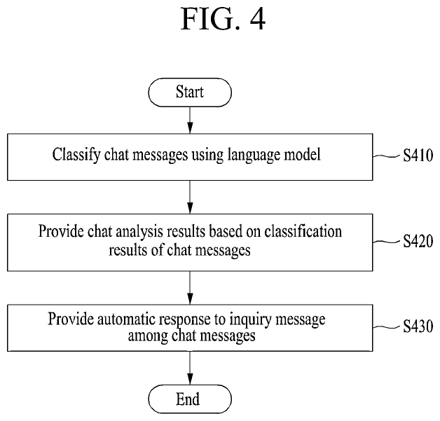

FIG. 3 is a block diagram illustrating an example of a component included in the processor 220 of the computer device 200 according to an example embodiment, and FIG. 4 is a flowchart illustrating an example of a live inspector method performed by the computer device 200 according to an example embodiment.

The computer device 200 according to the example embodiment may provide a live commerce service to a client device (i.e., electronic devices 110, 120, 130, 140) through a dedicated application installed on the client device or access to a web/mobile site related to the computer device 200.

Herein, a live commerce service represents an online channel that sells products through real-time video streaming and may represent a streaming broadcast service that combines chat and shopping and introduces products while communicating with viewers of the products in real time through chat.

Referring to FIG. 3, the processor 220 of the computer device 200 may include a chat classifier 310, a chat analyzer 320, and an automatic responder 330, as components to perform a live inspector method to be described below. Depending on example embodiments, components of the processor 220 may be selectively included in or excluded from the processor 220. Also, depending on example embodiments, the components of the processor 220 may be separated or merged for functional expression of the processor 220.

The processor 220 and the components of the processor 220 may control the computer device 200 to perform operations included in the live inspector method to be described below. For example, the processor 220 and the components of the processor 220 may be implemented to execute an instruction according to a code of at least one program and a code of an OS included in the memory 210.

Here, the components of the processor 220 may be expressions of different functions performed by the processor 220 in response to an instruction provided from a program code stored in the computer device 200. For example, the chat classifier 310 may be used as a functional expression of the processor 220 that controls the computer device 200 to classify chat messages in response to the instruction.

The processor 220 may read a necessary instruction from the memory 210 to which instructions related to control of the computer device 200 are loaded. In this case, the read instruction may include an instruction for controlling the processor 220 to execute the live inspector method to be described below.

Operations included in the live inspector method to be described below may be performed in order different from illustrated order and some of operations may be omitted or an additional process may be further included.

Referring to FIG. 4, in operation S410, the chat classifier 310 may classify messages received from the viewers of the products being shown through an online channel during a live broadcast using a chat function that is one of the functions provided through a live commerce tool, i.e., a tool for providing various functions related to a live commerce service, such as the ability to broadcast the host's live broadcast and the ability to communicate with viewers during the host's live broadcast. For example, the chat classifier 310 may classify a chat message into a category corresponding to message content using a language model. The chat classifier 310 may perform category classification of a chat message received in real time using a prompt that is an input text of the language model. The category that is the classification item of the chat message may be directly set according to a selection from a host that is a product seller of a live commerce channel, and depending on example embodiments, may be automatically set according to product information registered by the host, that is, a product item introduced by the host. For example, the chat classifier 310 may classify a viewer's chat message into greeting, reaction (positive/negative), inquiry, order, or confirmation request depending on the content of the corresponding message.

In operation S420, the chat analyzer 320 may provide chat analysis results in real time based on classification results of the chat messages in the live commerce platform. The chat analyzer 320 may analyze the chat messages of the viewers in real time and may visualize, i.e., generate, analysis results. For example, the chat analyzer 320 may visualize positive/negative rates in the form of a chart (e.g., a circular chart, a linearized curve graph, etc.) using messages corresponding to a reaction message category among the chat messages of the viewers. As another example, the chat analyzer 320 may automatically generate and highlight a positive reaction based on a positive reaction rate of the viewers. As another example, the chat analyzer 320 may store a message classified as a negative reaction among the chat messages of the viewers and may use the same as additional analysis data in relation to the host's product after the live broadcast ends.

In operation S430, the automatic responder 330 may provide an automatic response to the viewer's chat message. The automatic responder 330 may provide an answer to a message classified into an inquiry category among the chat messages of the viewers. For example, the automatic responder 330 may provide an automatic response to an inquiry message of a viewer based on a dataset (pair of expected inquiry and answer for each inquiry) provided in advance by the host. As another example, the automatic responder 330 may provide an automatic response to an inquiry message of a viewer based on product information (e.g., product specifications, inventory, etc.) of the host in conjunction with a shopping platform related to live commerce. As another example, the automatic responder 330 may provide an automatic response to an inquiry message of a viewer based on a dataset that converts the host's voice to text through speech to text (STT) during a live broadcast. As another example, the automatic responder 330 may provide an automatic response to an inquiry message of a viewer based on a dataset (inquires and answers for the respective inquiries in previous broadcast) acquired during previous live broadcasts of the same product or similar products. That is, if there is a sufficient dataset accumulated from previous broadcasts for a product introduced by the host, the automatic responder 330 may provide an automatic response to a more general and broader inquiry. Here, the automatic responder 330 may save a corresponding inquiry and answer for a viewer inquiry to which an automatic response was successfully generated and may automatically post the same to an inquiry bulletin board related to the product of the host. The inquiry bulletin board may be provided through a user interface screen of the viewer. Also, the automatic responder 330 may separately collect an inquiry to which an automatic response has failed among the inquiry messages of viewers and may provide the same through a separate interface on which the host may focus.

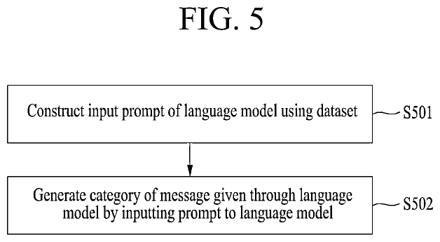

FIG. 5 is a flowchart illustrating an example of a message classification process using a prompt according to an example embodiment.

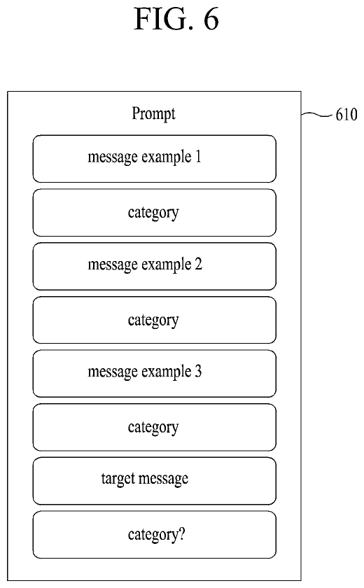

Referring to FIG. 5, in operation S501, the processor 220 may construct an input prompt of a language model using an example dataset. The processor 220 may use a predetermined message and a category of the corresponding message as example data. In addition to a predetermined example data pair, a separate dataset may be present and, depending on example embodiments, an example data pair including a message and a category of the message may be selected within a dataset and used. The processor 220 may generate a dedicated prompt template that well reflects characteristics of a given natural language processing (NLP) problem. Here, the prompt template may include task definition or meta information. That is, the processor 220 may construct a prompt in the form of a natural language using example data selected from a dataset. Here, the prompt is constructed in a format that may be understood by the language model and given as input to the language model. When the example data is data with a label, the processor 220 may design the prompt such that an input statement may be generated with label information. The format of the prompt may be variously designed and, for example, the prompt may include a message example (e.g., example of sentence exchange through chat) and a category of the corresponding message as an example. Herein, the prompt may include an example data pair including at least one message and a category of the corresponding message and a target message, e.g., a chat message received in real-time from a viewer. A detailed method of constructing the prompt is described with reference to FIG. 6.

In operation S502, the processor 220 may understand a category of a target message given from the language model by inputting the prompt constructed in operation S501 to the language model. The processor 220 may acquire the category of the target message as language generation results through a generation or complete function of the language model after inputting a prompt input statement into the language model. The processor 220 may acquire new results with a corresponding pattern by inputting the prompt to the language model and by analyzing a natural language pattern of an example included in the prompt through the language model.

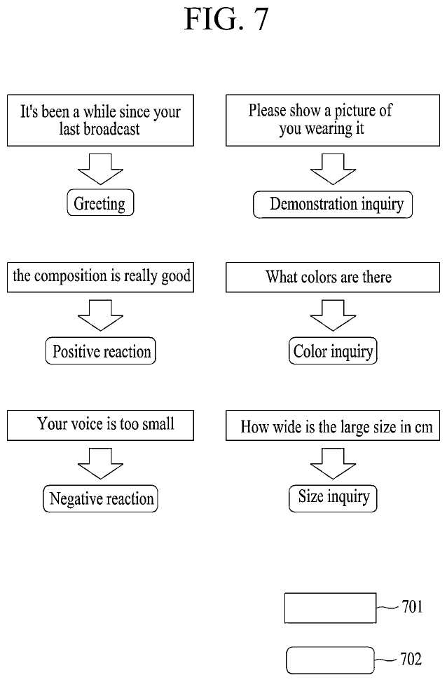

FIGS. 6 and 7 illustrate category classification examples according to an example embodiment.

Referring to FIG. 6, the processor 220 may construct a prompt 610 that is an input statement of a language model using an example data pair including a message example selected as example data and a category of the corresponding message.

The processor 220 may input the prompt 610 including at least one example data pair and a target message to the language model, such that the language model may generate a category for the target message. That is, the category corresponding to content of the target message may be generated through the complete function of the language model.

The processor 220 may generate the category for the target message according to a pattern of example data included in the prompt using the prompt 610 including an example data pair in the form of [message example+category] and [target message].

For example, as shown in FIG. 7, when a chat message from a viewer received in real time is given as a target message 701, the processor 220 may input example data and the target message 701 to the language model through the prompt 610 and may generate a category 702 corresponding to the target message 701 according to a pattern of the example data.

That is, the processor 220 may provide a message and a category of the corresponding message as an example and may generate classification information, that is, category for the target message according to a pattern of the example.

The processor 220 may establish a unique classification criterion for each host without separate model learning using the language model and may provide message classification results according to the criterion in real time through a user interface screen on the computer device 200 of the host.

Although it is described above that the language model is used for the message classification, a machine learning model-based classifier may also be used without being limited thereto. The processor 220 may predict and classify a category of a message received in real time through the machine learning model trained with a dataset for category classification.

The processor 220 may use the language model to generate an automatic response to an inquiry in addition to the message classification. That is, the processor 220 may provide question-and-answer data related to a product of the host as an example and may generate an answer to content of a target inquiry according to a pattern of the example. Therefore, the processor 220 may generate and provide the automatic response to the inquiry using the language model.

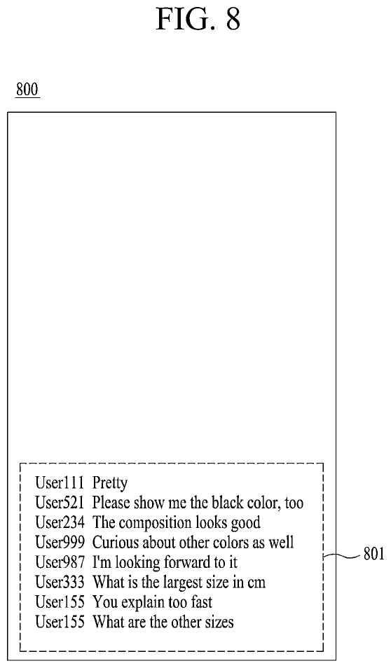

FIG. 8 illustrates an example of a live commerce interface screen according to an example embodiment.

Referring to FIG. 8, the processor 220 may provide a live broadcast screen 800, which is a live commerce interface screen, to a host and a viewer. The processor 220 may display chat messages exchanged with viewers in real time during live broadcast on a chat area 801 provided on one side of the live broadcast screen 800.

The processor 220 may sort the chat messages from the viewers in order in which the chat messages are received and may display the same on the chat area 801. Here, chat messages disappear from the chat area 801 in order of oldest reception time.

When a chat volume is large during live broadcast, a viewer inquiry received through a chat message quickly disappears from the chat area 801. Therefore, the host may miss the viewer inquiry or may not provide an answer to a viewer in time.

Considering such issues, a chat-based live commerce platform may provide an inspector with various functions that processes chat messages in real time using a live commerce tool of the host.

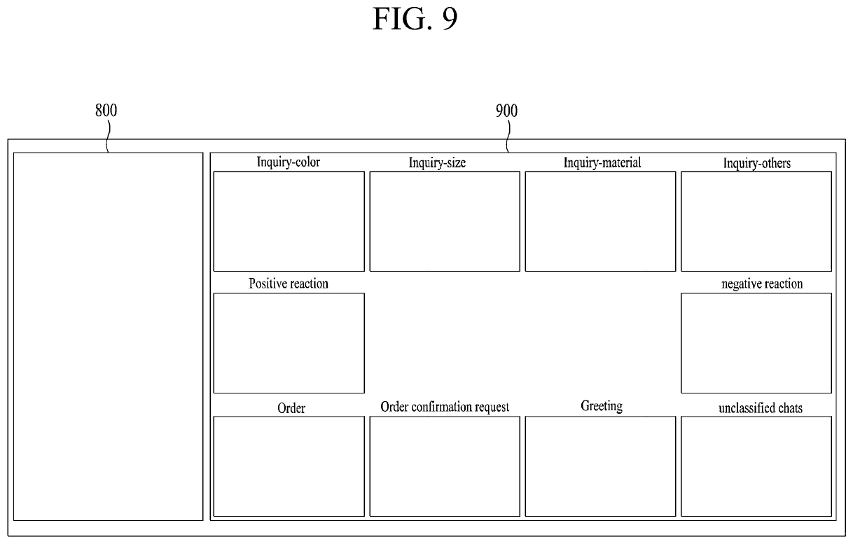

FIGS. 9 to 11 illustrate examples of an interface screen of a live commerce tool according to an example embodiment.

Referring to FIG. 9, the processor 220 may provide a host inspector screen 900 to the host as an administrator interface screen with the live broadcast screen 800 provided to the viewer.

The processor 220 may provide a classification template to the host in advance and, here, may construct and provide the host inspector screen 900 with only templates desired by the host. Here, the processor 220 may recommend the classification template of chat messages based on a broadcast item of the host. For example, the host may select positive reaction, negative reaction, color inquiry, size inquiry, material inquiry, other inquiry, order, order confirmation request, and greeting, as classification items for chat messages of viewers from among various classification items of the classification template. That is, the host inspector screen 900 may be configured with a template of items for which the host desires to classify chat messages.

The processor 220 may classify chat messages of viewers through a language model or a machine learning-based classifier and, here, may flexibly classify the chat messages in a manner (classification item) desired by the host.

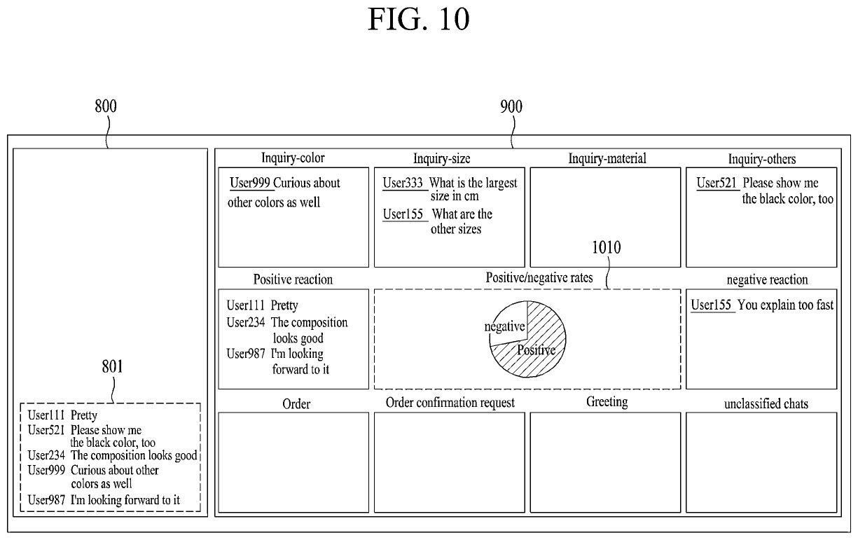

The processor 220 may display classification results of chat messages on the host inspector screen 900 in real time. As shown in FIG. 10, with the progress of live broadcast, the processor 220 may classify chat messages displayed on the chat area 801 of the live broadcast screen 800 by item and may display the same on the host inspector screen 900.

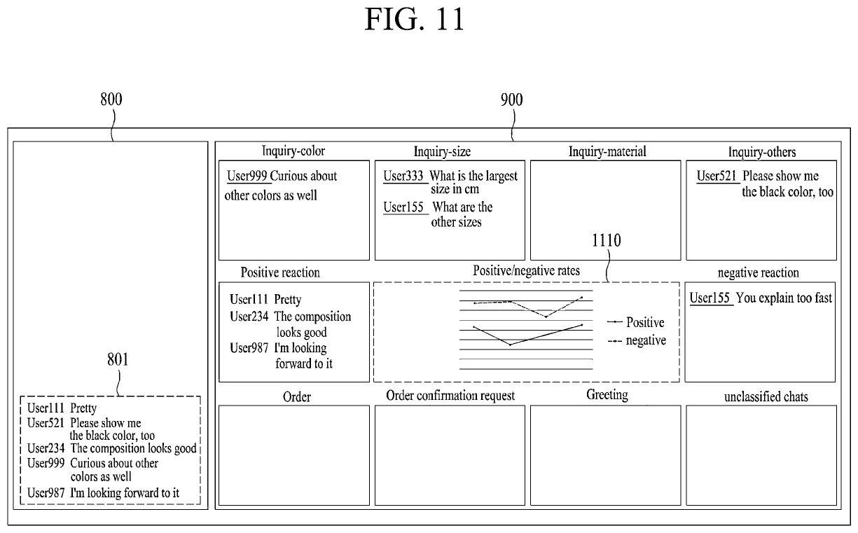

The processor 220 may display, on the host inspector screen 900, results of analyzing chat messages of viewers in real time. For example, the processor 220 may visualize, i.e., generate, positive/negative rates based on messages classified into a reaction category among chat messages of viewers. For example, as shown in FIG. 10, the processor 220 may visualize and provide positive/negative rates according to reaction messages of viewers using a circular chart 1010. Alternatively, as shown in FIG. 11, the processor 220 may visualize and provide positive/negative rates according to reaction messages of viewers using a linearized curve graph 1110.

The processor 220 may classify chat messages of viewers into classification items (e.g., positive reaction, negative reaction, color inquiry, size inquiry, material inquiry, other inquiry, order, order confirmation request, and greeting) selected by the host and may classify remaining chat messages into an unclassified chat item and display the same on the host inspector screen 900.

When the host selects a filter for abusive messages as one of classification items, the processor 220 may classify and process, as abusive, prohibited words, such as slang, swear words, and disparaging remarks, among chat messages of viewers. An abusive message may be redacted or replaced with a symbol and displayed.

The processor 220 may construct a prompt of the language model based on unclassified chat messages after the live broadcast ends or may modify the text for pre-training a classifier model.

If there are many chat messages corresponding to a classification item (category) not previously used by the host, the processor 220 may add the same as a message classification item on the host inspector screen 900 during subsequent live broadcast of the corresponding host. Depending on example embodiments, the processor 220 may recommend a chat message classification item, which was frequently used in previous live broadcasts, in the process of selecting a classification template for constructing the host inspector screen 900.

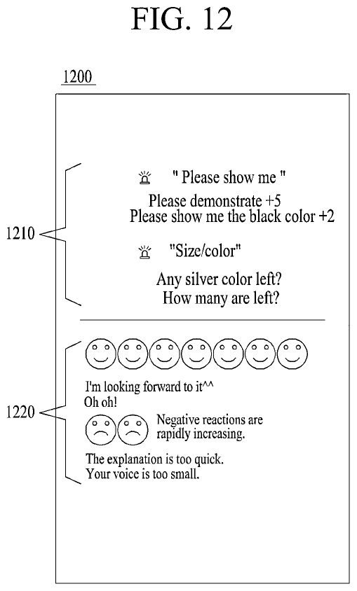

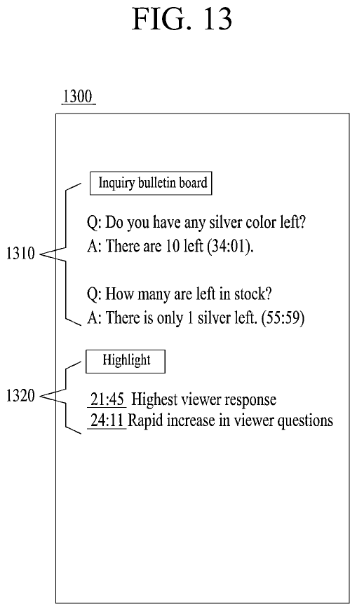

FIGS. 12 and 13 illustrate other examples of an interface screen according to an example embodiment.

FIG. 12 illustrates a host inspector screen 1200.

Referring to FIG. 12, the processor 220 may provide results 1210 of classifying chat messages of viewers and chat analysis results 1220 based on classification results of the chat messages through the host inspector screen 1200.

FIG. 13 illustrates a viewer inspector screen 1300.

Referring to FIG. 13, the processor 220 may provide an inquiry bulletin board 1310 including an inquiry message and an automatic response (host reply) and highlighted information 1320 generated based on chat analysis results, through the viewer inspector screen 1300.

The processor 220 may automatically post and provide a corresponding inquiry and answer for viewer inquiries to which automatic responses were successfully generated to the inquiry bulletin board 1310 of the viewer inspector screen 1300.

The processor 220 may generate highlighted information based on results of analyzing chat messages of viewers. For example, the processor 220 may provide a point in time at which positive reactions rapidly increased and a point in time at which viewer inquiries rapidly increased during the live broadcast, as the highlighted information 1320.

When the highlighted information 1320 is selected, the processor 220 may provide a broadcast video of a corresponding highlight section.

The processor 220 may post the highlighted information 1320 with product information of the corresponding host registered to a shopping platform in conjunction with the shopping platform related to live commerce.

As described above, according to some example embodiments, by providing a function of classifying and analyzing chat messages in real time as an inspector role on a chat-based live commerce platform, it is possible to advance a live commerce tool.

The apparatuses described herein may be implemented using hardware components, software components, and/or combination of the hardware components and the software components. For example, the apparatuses and the components described herein may be implemented using one or more processing devices which may be general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, to be interpreted by the processing device or to provide an instruction or data to the processing device. The software also may be distributed over network coupled computer devices so that the software is stored and executed in a distributed fashion. The software and data may be stored by one or more computer readable storage media.

The methods according to the example embodiments may be configured in a form of program instructions performed through various computer methods and recorded in computer-readable media. Here, the media may continuously store computer-executable programs or may transitorily store the same for execution or download. Also, the media may be various types of recording devices or storage devices in a form in which one or a plurality of hardware components are combined. Without being limited to media directly connected to a computer device, the media may be distributed over the network. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of other media may include record media and storage media managed by an app store that distributes applications or a site that supplies and distributes other various types of software, a server, and the like.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A method executed by a computer device having at least one processor configured to execute computer-readable instructions stored in a memory, comprising:
classifying chat messages received during a live broadcast of a host using a function of a live commerce tool for the host.

2. The method of claim 1, wherein the chat messages are classified into a category corresponding to message content using a language model.

3. The method of claim 1, wherein the classifying of the chat messages comprises:
constructing a prompt for a target message using example data that includes a message example and a category of the message example; and
generating a category of the target message according to a pattern of the example data by using the prompt as input to a language model.

4. The method of claim 1, wherein the classifying of the chat messages comprises:
setting a category that is a classification item of the chat messages for the live broadcast; and
classifying the chat messages into the set category and displaying the set category and the chat messages through an interface screen configured with a template of the category.

5. The method of claim 1, wherein the method further comprises analyzing the chat messages received during the live broadcast in real time using the function of the live commerce tool and providing analysis results.

6. The method of claim 5, wherein the providing of the analysis results comprises visualizing positive and negative reaction rates based on the classification results of the chat messages.

7. The method of claim 5, wherein the providing of the analysis results comprises generating and providing highlighted information related to a specific classification item based on the classification results of the chat messages.

8. The method of claim 5, wherein the providing of the analysis results comprises storing a message of a specific classification item based on the classification results of the chat messages, and
the message of the specific classification item is used as analysis data related to the host's product.

9. The method of claim 1, further comprising providing an automatic response to an inquiry message classified into an inquiry category among the chat messages using the function of the live commerce tool.

10. The method of claim 9, wherein the automatic response is provided based on a response dataset provided in advance by the host.

11. The method of claim 9, wherein the automatic response is provided based on at least one of the host's product information, a dataset converted from the host's voice through speech to text (STT), and a dataset accumulated from the host's previous broadcast.

12. The method of claim 9, wherein the providing of the automatic response comprises automatically posting an inquiry and a corresponding response to a bulletin board related to the host's product for the inquiry message to which the automatic response was successfully generated.

13. The method of claim 9, wherein the providing of the automatic response comprises providing the inquiry message to which a generation of the automatic response has failed through a separate interface.

14. A non-transitory computer-readable recording medium storing a computer program for execution the method of claim 1 on a computer device.

15. A computer device comprising:
at least one processor configured to execute computer-readable instructions included in a memory,
wherein the at least one processor is configured to classify chat messages received during a live broadcast of a host using a function of a live commerce tool for the host.

16. The computer device of claim 15, wherein the at least one processor is configured to classify the chat messages into a category corresponding to message content using a language model.

17. The computer device of claim 15, wherein the at least one processor is configured to,
set a category that is a classification item of the chat messages for the live broadcast, and
classify the chat messages into the set category and display the set category and the chat messages through an interface screen configured with a template of the category.

18. The computer device of claim 15, wherein the at least one processor is configured to analyze the chat messages received during the live broadcast in real time using the function of the live commerce tool and to provide analysis results.

19. The computer device of claim 15, wherein the at least one processor is configured to provide an automatic response to an inquiry message classified into an inquiry category among the chat messages using the function of the live commerce tool.

20. The computer device of claim 19, wherein the at least one processor is configured to provide the automatic response based on at least one of the host's product information, a dataset converted from the host's voice through speech to text (STT), and a dataset accumulated from the host's previous broadcast.
